(19) United States
(12) Patent Application Publication
(10) Pub. No.: US 2006/0259766 A1
(43) Pub. Date: Nov. 16, 2006

(54) System and method to protect personal identity identifiers

(76) Inventor: Mehran Randall Rasti, Baton Rouge, LA (US)

Correspondence Address: Mehran R. Rasti, 13040 Sugar Bowl Ave., Baton Rouge, LA, 70814, US

(21) Appl. No.: 11/129,827

(22) Filed: May 16, 2005

(51) Int. Cl. H04L 9/00

(52) U.S. Cl. 713/168

(57) ABSTRACT

This invention teaches methodology for implementing password authentication of social security numbers, and other such identity identifier objects, with the aim to curb unwarranted use of peoples' identity identifiers. The invention introduces an identity-matrix and related methodology. Together, they comprise a system that is a combination of a person's social security number, and other identity identifier objects, with a large number of different passwords. With this method of operation, a third party looking to authenticate a person's identity must verify a pre-designated password that is associated with the same identity identifier, from additional two independent sources. Those being a trustee organization issuer of such identity-passwords, and the other being the person whose identity is being verified. Authentication of identity is concluded, should all obtained identity-passwords match.

### CROSS REFERENCE TO RELATED APPLICATIONS

U.S. Pat. No. 6,871,287 Mar. 22, 2005 Ellingson; J. F. U.S. Pat. No. 6,862,610 Mar. 1, 2005 Shuster, G. S. U.S. Pat. No. 6,859,524 Feb. 22, 2005 Unger, N. K. U.S. Pat. No. 3,995,741 Dec. 7, 1976 Joseph Henderson

### FEDERALLY SPONSORED RESEARCH OR DEVELOPMENT

Not Applicable

REFERENCES TO SEQUENCE LISTING, TABLES, OR COMPUTER PROGRAMS

Tables:

Not Applicable

Computer Programs:

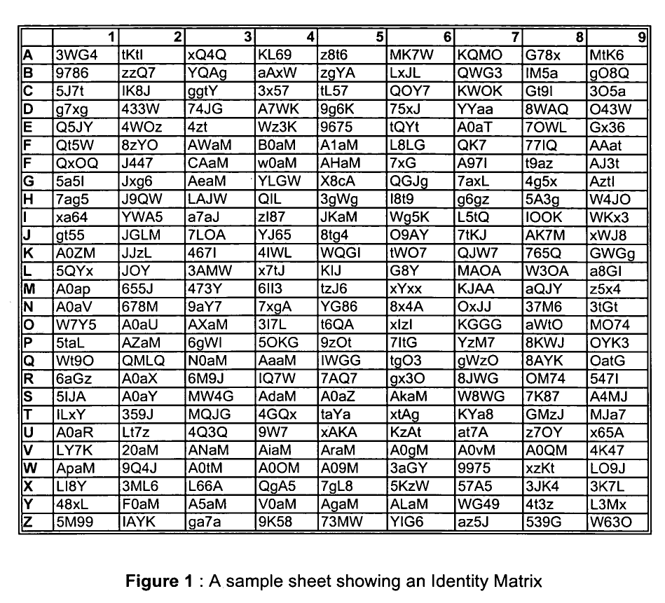

Appendix-A contains two program listings by names of MkAnF1P and MkSht1. These are to illustrate a method used in generating instances of Identity Matrix, of claim 1, that is similar to those illustrated in FIG. 1, Appendix-B.
a) The first program is used to generate an ordered list of character strings resulting from permutations of characters contained, in the “Starting Character String”, and to output it to a one column table (file). The supplied starting-character-string would be the first instance, with its successive permutations to follow; until all characters of the string are exhausted, using the 62 possible alphanumeric character variations. The longer the starting character string, the more number of strings become possible.
b) The second program, accepts a list of character strings (in a 1 column source table) produced by the first program, and formats it into a matrix. This matrix is for illustration purposes, only. A commercial version of the program would use elaborate schemes to produce an entirely unpredictable order of passwords within the cells of the produced matrix.

It is to be understood that many variations of such programs are possible, and in order to produce maximum unpredictability in the output results, commercial implementations would have to considerably be more complex, and of secretive nature.

### BACKGROUND OF INVENTION

1. Field of Invention
The invention presents a method to curb the ever increasing instances of personal identity theft by imposing a series of selectable passwords on one's social security number or other vital personal identifiers.
Personal identification identifiers, such as the social security number, finger print, or retina patterns, are of fixed nature; meaning, they stay with a person for life. Therefore they need to be protected. However, during course of time in the information age, and with constant use, such fixed data become exposed, and in essence will fall in the public domain; they become stale, and ultimately useless, when used unguarded and without passwords. This invention fortifies such identity indicators with numerous passwords; all of which are known to the owner of an identity, but only one or two of which is disclosed to third parties for doing business. This kind of exposure would occur in a controlled manner, and with the law catching up, they will be better controlled through a trustee organization. A trustee organization is set up to issue such passwords, to manage their release, and to enforce the related rules. Under this approach, an owner of such passwords can change them after a period of time upon request, and when he/she should feel that the passwords may have fallen into too many hands.

2. Status of Prior Art
Social security number was not created to serve as a publicly used identity identifier, and was never intended to become people's national identification number in the United States. In recent times, it has wrongfully become the primary means of authenticating personal identity and a tool used in credit history checks. The computer age and mass storage of this identity indicator had not been anticipated. Currently, the social security numbers of any person can be obtained and misused by any criminal who would be after it. Given time, other forms of identity identifiers that look glamorous and sophisticated today, would follow the same fate, as the social security number. A few examples that can be mentioned are: digital finger prints, retina markings, ear lobe patterns, voice frequencies and inflections, or other biometric data, some of which are yet to be discovered and placed in use.
To date, no attempt has been made to place passwords on social security numbers that are so commonly in use, and that are copied all over the place. Methodology and concepts that are introduced here can be utilized to protect and guard the usage of the social security number, as well as other identity identifiers mentioned above.

### SUMMARY OF THE INVENTION

1. In order to gain a level of security, control, and authentication, a trustee organization will receive a certified request by a person to allocate passwords to his/her social security number, or other identity identifiers.
2. The trustee examines the authenticity of certifications made on such documents, and will issue a number of randomly generated character strings as passwords to the owner of identity identifier. These are to be solely used for the purpose of identity authentication, its verification, and to secure one's identity.
3. The trustee, then sends the identity identifier, along with its associated passwords to the identity owner in a matrix of many cells. This is named “identity matrix”, and may be in electronic form, or printed on paper. See claims 1, and 3.
4. The printed form of the matrix has row names of A-Z, and columns names of 1-9. The intersection of a row and a column forms a cell. Each cell contains a 1-4 random character string, called “identity password”, and is referenced by its corresponding row and column names, in that order. For example, calling out “G5X8cA” indicates the password of “X8cA” in row G, column 5 of a person's identity matrix. See FIG. 1, appendix-B.
5. The owner of the identity-password keeps his/her “identity matrix” in an accessible, but safe place for quick reference. The owner must not disclose his/her identity-passwords to anyone, but to legitimate third parties who are registered with the trustee, and who only would ask for the identity-passwords by cell name they are authorized to have and use.
6. A third party, such as a financial institution, who needs to authenticate a person's identity number, will have to contact the trustee organization first, and open an account. During this process, the trustee will verify the credibility of the third party, justifies business and security needs of the organization for the type of the business and functions they perform. Based on this, the trustee will decide and allocate “read access” to one, but no more than 3 cell contents, by name. For example, Village Bank of America will be assigned read access only to cell named G5 for all its customers.
7. The trustee will release the contents of the cells to the authorized third party upon receiving a request, for a small fee. This is done via secure mail or through secure communication means. The registered third party, who is set out to authenticate a person, has now in its possession, only one, out of about 234 cell passwords, that a person can expend.
8. The third party, above, will then contact the person whose identity it needs to verify, and will request the person to release the password content of the preauthorized cell it is allowed to have. This must be in writing and/or done via secure mail, or other secure means of communication.
9. At this stage, the third party is able to authenticate the person by matching the two passwords obtained out of the procedures in steps 7 and 8, above.
Steps 2-9 is according to a method of claim 2.
Security is made possible due to a large pool of identity passwords a person has to expend. If all passwords are lost, or stolen, or should a person feel insecure about them being in too many places, he/she can send a request to trustee for issuance of a new matrix of passwords.
It is important to note that there are over 17 million 1-4 letter password variations possible out of permutations of 64 characters. This dictates the extent of security available to the public. The odds of one or more people having the same identity password in the same cell of the matrix, is estimated to be one in several million.

### DESCRIPTION OF THE DRAWINGS

Appendix-B contains two figures to help illustrate techniques used in a method of claim 2. These are:

a) FIG. 1, a sample sheet showing an Identity Matrix. This is similar to the ones that are sent to the public. On this sheet, the indicated “Reference No.” (top left) relates to person's social security number or other personal identity identifier of a person the matrix is issued to. This reference number is used in lieu of a person's social security number at the top of the matrix, for security reasons, and in case the sheet is lost, or misplaced.

All random identity-passwords that are issued to a person are shown in the squares of this sheet, designated as cells of the identity-matrix. These passwords are different for different people. Row names of A-Z appear in the far left column, and column names of 1-9 appear in the very top row.

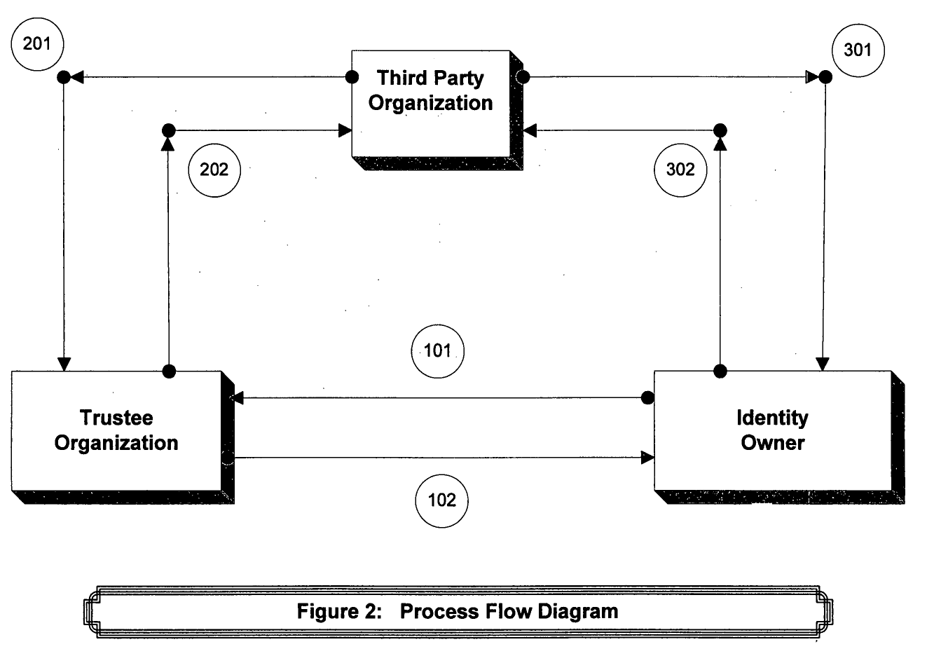

b) FIG. 2, is a process flow diagram showing the entities involved, and sub-processes relating to a method of claim 2. In this diagram, sub-processes are numbered in small circles. These are used for reference in explaining the method of claim 2, under the heading of “Detailed Description”.

### DETAILED DESCRIPTION

1. A person interested in gaining better control of his/her social security number, or other forms of identity identifiers to come, obtains, sends for, or downloads, the necessary contracts and forms from a trustee organization for issuance of what is referred to as “Identity Matrix” according to claim 1. See FIG. 1, Appendix-B.
2. The person will read, comprehend, and agree to the legal agreement on said forms specifying the role, duties, legal responsibilities, and scope of liabilities pertaining to a trustee organization issuing and maintaining a matrix of identity-passwords. The passwords are to be used for authentication of personal identity with financial institutions, governmental agencies, checking a person's credit rating, getting a credit card, and the like.
3. The person will complete an application form with the identity identifier he/she plans to restrict, along with his/her name, birth date and other information to indicate that he/she is the person referenced on the application form, and no other.
4. The person takes the application form to a notary public, and/or other authorities along with one or two picture id's, and notarizes the application form as a binding, legal document.
5. The person then, sends the certified application form to the trustee with certified mail or other traceable forms of document transfer. See FIG. 2, in Appendix-B. A secure digital link along with digital signatures or any other means acceptable to trustee, may be used. Reference to this sub-process is designated on FIG. 2 with circle number 101.
6. A sheet of paper resembling a spreadsheet with intersecting rows and columns, similar to the one shown in FIG. 1, Appendix-B is mailed out to the person whose identity we want to guard. This sub-process is noted in FIG. 2, with circle numbered 102.
7. Looking at FIG. 1, the intersection of a row with a column is referred to as an “Identity Cell”, within the identity-matrix. Some character strings are printed in each identity-cell. These are named “Identity Passwords”, and are for now, made up of upper-case, lower-case, and special characters—forming password strings of 1 to 4 characters long. The number of characters may be increased in the future to accommodate more variations of passwords issued. Currently a set of 64 characters are used. With this we have produced just under 17 million character permutations, with no repeats.
8. Each identity-cell of claim 1 is referenced by its row and then by its column name, in that order. In FIG. 1, Appendix-B, we can see 234 cells containing identity-passwords, within a matrix of 26 rows (A-Z) by 9 columns (1-9). Sheets like this, containing random permutations of 1-4 character passwords, are generated by a trustee organization for each person applicant of steps 1-7, above.
9. Represented by the process flow path labeled as 102, on FIG. 2, a different identity-matrix is sent to each person whose identity is to be verified according to a method of claim 2. At this point, the applicant person has all of the identity-passwords issued to him/her at his/her possession.
10. Each identity-password of steps 6 and 9, above, is referenced by its row and column name. For example, referring to FIG. 1, Appendix-B, the identity-password in the identity-cell of row Y, column 9, is written as “Y9L3Mx”.
11. A third party organization, like a bank, a credit card company, a governmental agency, a car dealer, and the like who are planning to verify the credit history or the id of a person whose social security number (or other identity identifiers) are armed with the password protection method of claim 2, must open an account with the trustee organization who has issued the person's identity password. This is represented by sub-process number 201, in FIG. 2. The process of opening an account accomplishes the following objectives:
   a) The trustee organization will have an opportunity to verify the legitimacy of the third party organization, opening the account.
   b) The trustee organization is able to enforce any laws, rules and procedures that related to the confidentiality, safekeeping, and dissemination of social security number, and other sensitive identity information that are handed out to them by either the trustee, their clients, and other third parties; Here, client is referred to a person whose identity or credit background needs to be verified by the third party organization.
   c) Since the process involves expenses for the trustee, the trustee organization will be able to charge for services rendered, through this account.
   d) It gives the trustee organization the possibility to mandate any laws passed by the government, in the interest of protecting the identity of the public.
A third party organization who acts recklessly in safeguarding people's identity identifiers and identity-passwords can be barred from further damaging the general public by exposing them to un-necessary risks.
12. In this step, an authorized third party receives an identity-password of their client, from the trustee. This is represented by sub-process number 202, in FIG. 2. A third party organization with a valid account is assigned a read-only permission on a certain cell, by cell name. Such permission, entitles a third party organization to have access to a certain cell contents for all of their clients, by submitting a request through secure means. For example, if this company has been assigned cell Y9, they can request to have Jack Smith's identity-password in identity-cell named Y9, by supplying their client's identity identifier. In this case they are given: “Y9L3Mx”.
13. A third party organization wanting to run an identity check on its client, will ask him/her to disclose the identity-password contained in a cell of the client's identity-matrix they have been authorized to know. See sub-process 301 in FIG. 2. At this stage, the client will supply his/her identity-password and social security number (or other identity identifier), to the said third party, via a signed form, in confidence. See sub-process number 302, in FIG. 2.
14. The third party organization is in possession of the same cell content (identity-password) from two sources: from the trustee (step number 12, sub-process number 202) on one hand, and from the client (step 13, sub-process number 302), on the other hand.
15. The third party organization now compares the two identity-passwords that is supposed to belong to the same person. If they match, the identity of the person is confirmed, and his/her credit may be referenced, and/or accounts opened, etc.
To summarize, the invention combin2s an identity-matrix, according to claim 1, together with methods of claim 2, as explained in steps 1 through 15, above, comprising a system and method to verify and protect people's identity identifiers before they are used, and therefore, prevents such identity identifiers as the social security number from misuse and fraud. In summary, the invention is used for:
   a) informing a person whose social security number or his/her other identity identifiers are being interrogated and qualified for some purpose. Sub-process numbers 301 forces a third party to contact the person whose identity/credit history is being checked, and;
   b) discourages fraud, by making it harder, using the combination of sub processes 302, with 202. This makes it difficult for a phony person to pose as another person to steal one's identity.
As presented, the invention comprises a paper form of the identity-matrix, along with the manual version of methodology presented in claim 2.
Claim 3, on the other hand, modifies the above for use in an automated and electronic environment, where the matrix boundaries are not rows and columns, but one with a mess of data contained within its defined “data boundaries”. Such defined cells would house biometric data that are not visible to the eye, but can just as well be passworded for security. Claim 3 anticipates a fully electronic processing and protection of such data.

I claim:

1. An identity-matrix comprising many—identity password—within its cells that are linked to a person's social security number and other identity-identifiers, issued by a trustee organization, and assigned to a person; enabling him/her to impose security and control over usage of his/her identity identifiers.

2. The method of claim 1, wherein said personal identifier is a person's Social Security Number.

3. The method of claim 1, wherein said personal identifier is a person's finger-print patterns in digital data format.

4. The method of claim 1, wherein said personal identifier is any of a person's biometric data in digital data format.

5. The method of claim 1, wherein each of the said identity-identifiers is programmatically linked to many password cells within the said matrix.

6. The method of claim 1, wherein said personal identity-identifiers are programmatically combined with one or more data cell contents of the said matrix.

7. A method to authenticate said identity-identifiers and passwords in claims 1 through 7 using a three way authentication process amongst:
(a) an entity with interest in an end-result of an authenticated identity-identifier;
(b) a person to whom the identity-matrix belongs and characterizes him/her;
(c) a trustee organization that issues, maintains, and manages contents of the said identity-matrix.

8. A method of claims 1-7 for completing an identity authentication request comprising the steps of:
(a) trustee's inquiry and receipt of one or more identity-identifiers and passwords from a person-owner of an identity-identifier;
(b) issuance of passwords, populating, and altering data cell contents of said identity-matrix in claims 1 through 7 by the trustee organization;
(c) maintaining identity-identifiers and password contents of said identity-matrix in claims 1 through 7 for a person to whom the identity-matrix belongs, by the trustee;
(d) receiving a request for identity authentication by an entity;
(e) comparison and cross-reference of identity-identifier data received from a person to whom the identity-matrix belongs, with those received from an entity interested in a result of an identity-identifier authentication;
(f) feed back of authentication cross-comparison result by, and from trustee organization to the inquiring entity that initiated an identity authentication request.

9. A method of claim 7 that is irrespective of any particular order and sequence as is enumerated in that claim.

10. A method of claim 8 that is irrespective of any particular order and sequence as is enumerated in that claim.

11. A method for curbing identity theft originating from un-authorized use of social security number and/or other identity identifier through password authentication, comprising:
(a) a matrix comprising many passwords;
(b) a trustee organization
(i) receiving a qualified request from a person along with his/her social security number and/or other identity identifiers who is seeking to attach numerous—identity passwords—to his/her submitted social security number and/or other identity identifiers;
(ii) determining the ownership and authenticity of the identity identifiers received from the person he/she claims to be, before issuing any—identity password—;
(iii) generating enough random character strings placed in many cells of a matrix serving as—identity passwords—to be delivered or sent in confidence to the owner of the identity identifier;
(iv) recording all issued—identity passwords—in a confidential data base, kept in safety, and referenced via the identity identifier they correspond to;
(v) requiring to re-issue modified substitution passwords to owners of—identity passwords—when are affected by theft, or intrusive loss of documents and computer files bearing—identity passwords—;
(vi) pre-qualifying third party client organizations needing to authenticate people's identity by establishing client accounts; thus enabling them to receive people's—identity passwords—and enabling the trustee organizations's ability to enforce accountability on all issued—identity passwords—;
(vii) releasing a limited number of password contents of pre-designated cell addresses to third party client organizations having valid accounts—for the purpose of qualifying and authenticating peoples' identity.
(viii) serving the function specified in (vii) above, only after receipt the receipt of the identity identifier of a person they are serving;
c) an identity owner who
(i) at free will shall disclose, usually one, but no more than 3 (unless regulated by law) of his/her—identity passwords—to a third party whom he/she deems authorized to receive such confidential information with the understanding that such codes are regarded as being extensions of his/her social security number and/or other identity identifier;
(ii) acknowledges to have received a matrix of many of such—identity passwords—from the trustee;
(iii) shall safe keep and treat the entire matrix of the—identity passwords—as being confidential information, and in case of their loss or theft, he/she will inform the trustee, and law enforcement entities in a timely manner;
d) a third party
(i) seeking to authenticate the identity of people at large, establishes an account with the trustee organization by presenting enough evidence to justify genuine need to access peoples' identity identifiers;
(ii) having established an account and justified cause, a third party will obtain the password contents of one or more prescribed cell addresses from the trustee;
(iii) contacting the person whose identity is to verify, a third party will contact the person and obtain the password contents the same prescribed cell addresses;
(iv) authenticating the identity identifier of a person by comparing the results obtained from (ii), (iii), above;
(v) requiring safe keeping and confidentiality of all—identity passwords—it has in possession, and continual treatment, handling, and dissemination of all identity related data;
(vi) requiring notification of proper law enforcement and governmental agencies, in a timely manner, if and when it is established that a theft, or compromise of computer files and material bearing—identity passwords—has occurred;
(vii) requiring notification, in a timely manner of all affected people whose—identity passwords—are lost due to theft, or compromise of computer files and material bearing such information, when it establishes that such an event has occurred.

12. A matrix of cells comprising one or more cells of biometric and non-biometric identity identifiers in electronic form along with many cells of random passwords, also in electronic form to be processed together such that:
(a) passwords in one or more cells authenticate the identity data containing in another cell of the matrix, through electronic processing and;
(b) through digital processing, passwords in one or more cells control the release and validation of biometric or non-biometric data defined inside many other cell boundaries of the matrix.

13. A third party performing authentication process as specified in claim 11, section d), that is furnished with an identity identifier of a person it is going to authenticate, verifies the authenticity of the furnished passwords with the trustee, provided it has a functioning account with the trustee. The listed order of the authentication steps claim 11-d, does not dictate the sequence of events that need to take place for authentication.

14. In lieu of a third party, a trustee itself can authenticate the validity of an identifier password by following the steps designated in either of claims 8, or 13, above.
